(19) United States
(12) Patent Application Publication
(10) Pub. No.: US 2026/0171436 A1
(43) Pub. Date: Jun. 18, 2026

(54) GUIDE BLOCK FOR COATING A CATALYST OF A FUEL CELL AND A PRODUCING METHOD OF A CATALYST COATED MEMBRANE USING THE SAME

(71) Applicants: HYUNDAI MOTOR COMPANY, Seoul (KR); KIA CORPORATION, Seoul (KR)

(72) Inventors: Sung Hee Shin, Hwaseong-si (KR); Won Jae Choi, Hwaseong-si (KR); So Hwa Kim, Hwaseong-si (KR); Da Hee Kwak, Hwaseong-si (KR); Hyoun Myung Park, Hwaseong-si (KR); Ah Hyeon Park, Hwaseong-si (KR); Jee Youn Hwang, Hwaseong-si (KR); Songi Oh, Hwaseong-si (KR)

(73) Assignees: HYUNDAI MOTOR COMPANY, Seoul (KR); KIA CORPORATION, Seoul (KR)

(21) Appl. No.: 19/318,994

(22) Filed: Sep. 4, 2025

(30) Foreign Application Priority Data
Dec. 12, 2024 (KR) 10-2024-0184340

(51) Int. Cl. H01M 8/0273; H01M 4/88

(52) U.S. Cl. CPC H01M 8/0273; H01M 4/881

(57) ABSTRACT

A guide block for coating a fuel cell with a catalyst and a method of manufacturing a catalyst-coated membrane (CCM) using the same is provided. The guide block includes a pair of guide plates in a frame shape including a through-hole as an empty space in a center of the guide plates and a support plate disposed on at least one surface of the guide plate. The method of manufacturing a catalyst-coated membrane using a guide block includes interposing an electrolyte membrane between a pair of guide plates, disposing a support plate on a first surface of the guide plates, and forming a catalyst layer on the electrolyte membrane exposed to outside on a second surface of the guide plates.

### CROSS-REFERENCE TO RELATED APPLICATION

This application claims, under 35 U.S.C. § 119(a), priority to Korean Patent Application No. 10-2024-0184340, filed on Dec. 12, 2024, the entire contents of which are incorporated herein by reference.

### FIELD

The present disclosure relates to a guide block for coating a fuel cell with a catalyst and a method of manufacturing a catalyst-coated membrane (CCM) using the same.

### BACKGROUND

The statements in this section merely provide background information related to the present disclosure and may not constitute prior art.

Polymer electrolyte membrane fuel cells (PEMFC) may be classified into low-temperature and high-temperature types. A difference between these two fuel cell types lies in the operating temperature and the type of electrolyte membrane.

Low-temperature polymer electrolyte membrane fuel cells operate at about 60° C. to 80° C., and high-temperature polymer electrolyte membrane fuel cells operate at about 120° C. to 200° C.

Low-temperature polymer electrolyte membrane fuel cells include electrolyte membranes containing perfluorosulfonic acid ionomers such as Nafion, and high-temperature polymer electrolyte membrane fuel cells mainly include electrolyte membranes containing phosphoric acid-doped polybenzimidazole ionomers. Electrolyte membranes containing perfluorosulfonic acid ionomers require water for the conduction of protons, but electrolyte membranes containing phosphoric acid-doped polybenzimidazole ionomers are able to conduct protons even without water, so high-temperature polymer electrolyte membrane fuel cells may operate at temperatures of 100° C. or higher.

A polymer electrolyte membrane fuel cell includes a membrane-electrode assembly including an electrolyte membrane and a pair of electrode layers disposed on respective surfaces of the electrolyte membrane, a gas diffusion layer (GDL) on the membrane-electrode assembly, a separator on the gas diffusion layer, and the like.

The membrane-electrode assembly may be divided into, depending on the manufacturing method, a catalyst-coated gas diffusion layer (CCG) type in which an electrode layer is applied onto the gas diffusion layer to manufacture a laminate followed by attaching the stack to an electrolyte membrane, and a catalyst-coated membrane (CCM) type in which an electrode layer is transferred to an electrolyte membrane. The catalyst-coated membrane (CCM) type is advantageous in view of good interfacial bonding between the electrode layer and the electrolyte membrane, utilization of the catalyst, and the like.

Low-temperature polymer electrolyte membrane fuel cells have a solid electrolyte membrane, so the electrode layer may be easily transferred to the electrolyte membrane. However, high-temperature polymer electrolyte membrane fuel cells have a problem in that it is difficult to transfer the electrode layer to the electrolyte membrane because the electrolyte membrane is doped and/or impregnated with liquid phosphoric acid, and phosphoric acid leaks out due to the high temperature and pressure during the transfer process. Hence, the membrane-electrode assembly of a high-temperature polymer electrolyte membrane fuel cell is generally manufactured in the form of a catalyst-coated gas diffusion layer (CCG).

### SUMMARY

Various aspects are to provide a guide block for manufacturing a catalyst-coated membrane for a high-temperature polymer electrolyte membrane fuel cell.

Various aspects are to provide a guide block capable of manufacturing a catalyst-coated membrane by directly applying a catalyst layer onto an electrolyte membrane.

Various aspects are to provide a guide block capable of minimizing a dimensional change in an electrolyte membrane.

Various aspects are to provide a guide block capable of applying a catalyst layer onto both surfaces of an electrolyte membrane.

Various aspects are to provide a guide block capable of manufacturing a catalyst-coated membrane by a continuous process.

Various aspects are not limited to the foregoing. Various aspects should be clearly understood through the following description and to be realized by the means described in the claims and combinations thereof.

The present disclosure provides a guide block, including a pair of guide plates each having a frame shape having a through-hole as an empty space at a center portion of each of the pair of guide plates and a support plate disposed on at least one surface of a guide plate of the pair of guide plates.

Each of the pair of guide plates may include a fastening groove formed by being recessed in or penetrating a peripheral surface thereof.

The guide block may further include a fastening member configured to fasten the pair of guide plates by being inserted into the fastening groove.

At least one guide plate among the pair of guide plates may include at least one connecting portion protruding from an outer wall surface thereof and at least one receiving portion recessed in the outer wall surface.

The guide block may be configured to be connected to another guide block by joining the at least one connecting portion of the guide block to the at least one receiving portion of the other guide block.

The support plate may include a support portion protruding from a surface of the support plate and the support portion has a shape corresponding to a shape of the through-hole and is configured to be inserted into the through hole such that . the guide plate and the support plate may be coupled.

The support plate may include a gas discharge port formed to penetrate the support portion.

An inner wall surface of the guide plate may be formed to be inclined from a first surface of the guide plate toward a second surface thereof.

The present disclosure provides a method of manufacturing a catalyst-coated membrane using at least one guide block, where the at least one guide block includes a first guide plate and a second guide plate, each having a frame shape and including a through hole at a center portion thereof, and a first support plate and a second support plate. The method includes interposing an electrolyte membrane between the first guide plate and the second guide plate, disposing the first support plate on a first surface of the first guide plate, and forming a catalyst layer on the electrolyte membrane to be exposed to the outside via the through-hole on a second surface of the first guide plate.

The electrolyte membrane may be impregnated with phosphoric acid.

The first and second guide plates and the first and second support plates may be joined by inserting the support portion into the through-hole, and the electrolyte membrane may be supported by the support portion.

The method may further include disposing the second support plate on a first surface of the second guide plate and forming a catalyst layer on the electrolyte membrane to be exposed to the outside via the through-hole on a second surface of the second guide plate.

### BRIEF DESCRIPTION OF THE DRAWINGS

The above and other features of the present disclosure will now be described in detail with reference to certain embodiments thereof illustrated in the accompanying drawings which are given hereinbelow by way of illustration only, and thus are not limitative of the present disclosure.

FIG. 1 shows an exploded perspective view of a guide block for coating a catalyst according to an embodiment of the present disclosure.

FIG. 2A shows a plan view of the guide block according to an embodiment of the present disclosure.

FIG. 2B shows a left side view of the guide block according to an embodiment of the present disclosure.

FIG. 2C shows a cross-sectional view along line A-A′ of FIG. 2A.

FIG. 3A shows a plan view of a first guide plate according to an embodiment of the present disclosure.

FIG. 3B shows a left side view of the first guide plate according to an embodiment of the present disclosure.

FIG. 3C shows a right side view of the first guide plate according to an embodiment of the present disclosure.

FIG. 3D shows a rear view of the first guide plate according to an embodiment of the present disclosure.

FIG. 3E shows a cross-sectional view along line B-B′ of FIG. 3A.

FIG. 4A shows a plan view showing a form in which a plurality of guide blocks is connected according to an embodiment of the present disclosure.

FIG. 4B shows a perspective view showing a form in which the plurality of guide blocks is connected according to an embodiment of the present disclosure.

FIG. 5 shows a plan view of a second guide plate according to an embodiment of the present disclosure.

FIG. 6A shows a plan view of a first support plate according to an embodiment of the present disclosure.

FIG. 6B shows a right side view of the first support plate according to an embodiment of the present disclosure.

FIG. 7A shows a bottom view of a second support plate according to an embodiment of the present disclosure.

FIG. 7B shows a left side view of the second support plate according to an embodiment of the present disclosure.

FIG. 8A shows a bottom view of a first guide plate according to an embodiment of the present disclosure.

FIG. 8B shows a cross-sectional view along line C-C′ of FIG. 8A.

FIG. 9A shows a plan view of a first support plate according to an embodiment of the present disclosure.

FIG. 9B shows a right side view of the first support plate according to an embodiment of the present disclosure.

FIG. 10A shows a plan view of a second guide plate according to an embodiment of the present disclosure.

FIG. 10B shows a cross-sectional view along line D-D′ of FIG. 10A.

FIG. 11A shows a bottom view of a second support plate according to an embodiment of the present disclosure.

FIG. 11B shows a left side view of a second support plate according to an embodiment of the present disclosure.

FIG. 12 shows a method of manufacturing a catalyst-coated membrane (CCM) according to various aspects

FIG. 13 shows a manufactured guide block according to an embodiment of the present disclosure.

FIG. 14 shows a manufactured guide block according to an embodiment of the present disclosure.

FIG. 15 shows a catalyst-coated membrane (CCM) manufactured without using a guide block.

FIG. 16 shows a catalyst-coated membrane (CCM) manufactured using the guide block according to the present disclosure.

The drawings described herein are for illustration purposes only and are not intended to limit the scope of the present disclosure in any way.

### DETAILED DESCRIPTION

The above and other objects, features and advantages of the present disclosure should be more clearly understood from the following various aspects taken in conjunction with the accompanying drawings. However, the present disclosure is not limited to the various aspects disclosed herein, and may be modified into different forms. These various aspects are provided to thoroughly explain the disclosure and to sufficiently transfer the spirit of the present disclosure to those having ordinary skill in the art.

Throughout the drawings, the same reference numerals refer to the same or like elements. For the sake of clarity of the present disclosure, the dimensions of structures may be depicted as being larger than the actual sizes thereof. It should be understood that, although terms such as “first”, “second”, and the like, may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, when used in this specification, specify the presence of stated features, integers, steps, operations, elements, components, or combinations thereof, but do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

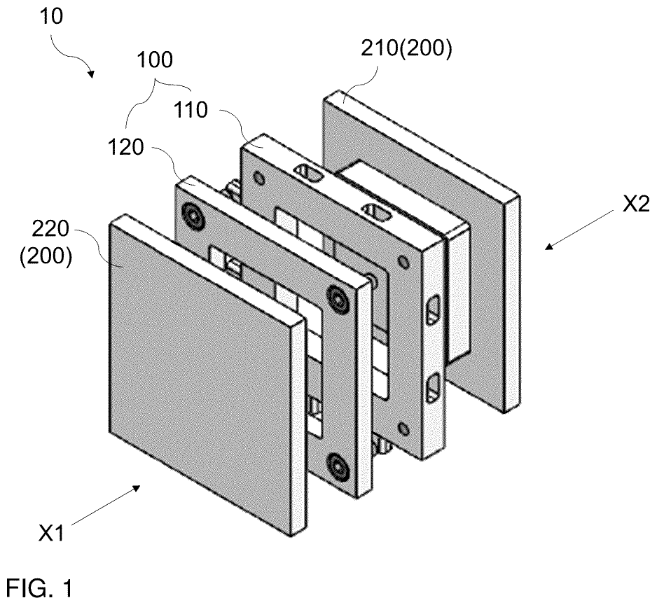

FIG. 1 shows an exploded perspective view of a guide block for coating a catalyst according to various aspects of the present disclosure. The guide block may include a guide block 10 having a pair of guide plates 100 and a support plate 200 disposed on at least one surface of the guide plates 100.

The pair of guide plates 100 may include a first guide plate 110 and a second guide plate 120. The support plate 200 may include a first support plate 210 disposed on the first guide plate 110 and a second support plate 220 disposed on the second guide plate 120.

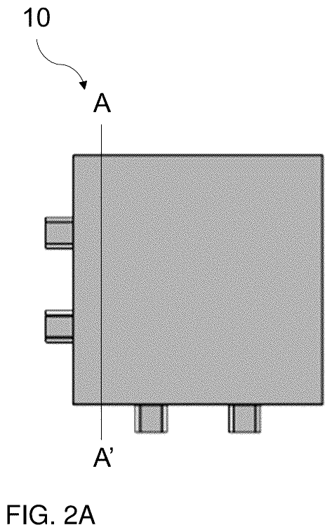

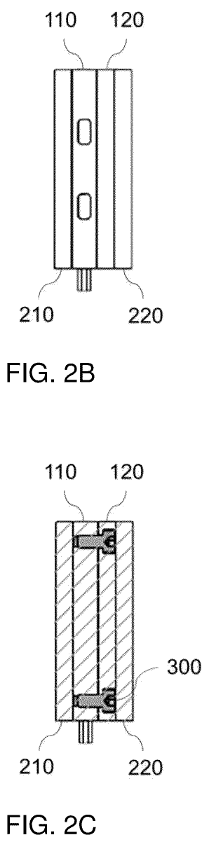

FIG. 2A shows a plan view of the guide block 10 according to various aspects of the present disclosure. Herein, the plan view shows the guide block 10 and the like as observed from the X1 direction of FIG. 1. In addition, the bottom view shows the guide block 10 and the like as observed from the X2 direction of FIG. 1. FIG. 2B shows a left side view of the guide block 10 according to various aspects of the present disclosure. FIG. 2C shows a cross-sectional view along line A-A′ of FIG. 2A. The first guide plate 110 and the second guide plate 120 may be joined by a fastening member 300.

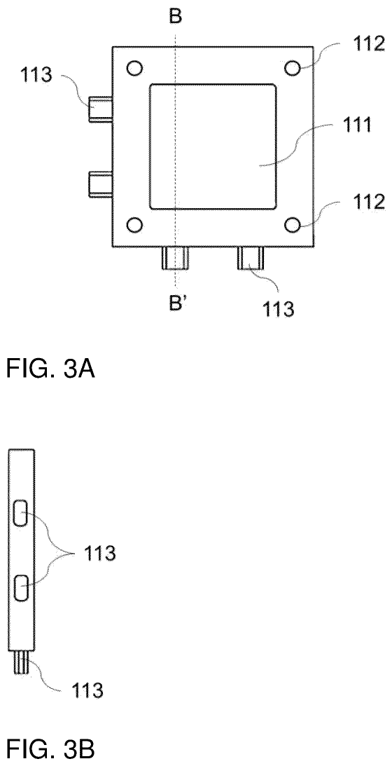

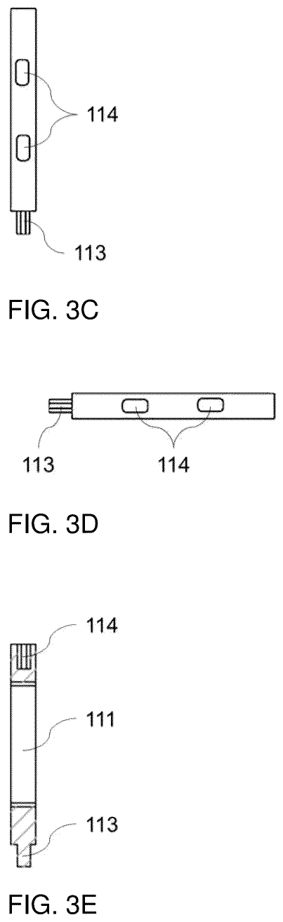

FIG. 3A shows a plan view of the first guide plate 110 according to various aspects of the present disclosure. FIG. 3B shows a left side view of the first guide plate 110 according to various aspects of the present disclosure. FIG. 3C shows a right side view of the first guide plate 110 according to various aspects of the present disclosure. FIG. 3D shows a rear view of the first guide plate 110 according to various aspects of the present disclosure. FIG. 3E shows a cross-sectional view along line B-B′ of FIG. 3A.

The first guide plate 110 may have a frame shape having a first through-hole 111, which is an empty space in the center of the first guide plate 110. The electrolyte membrane is exposed to the outside through the first through-hole 111, and a catalyst layer is formed on the electrolyte membrane exposed to the outside through the first through-hole 111, thereby manufacturing a catalyst-coated membrane (CCM).

The first guide plate 110 may include first fastening grooves 112 formed by being recessed in or penetrating the peripheral surface of the first guide plate 110. By joining the first guide plate 110 and the second guide plate 120 with the fastening member 300 through the first fastening grooves 112 and applying restraining force to the electrolyte membrane interposed therebetween, dimensions of the electrolyte membrane may be prevented from changing during coating with the catalyst layer.

The first guide plate 110 may include at least one connecting portion 113 protruding from the outer wall surface and at least one receiving portion 114 recessed in the outer wall surface.

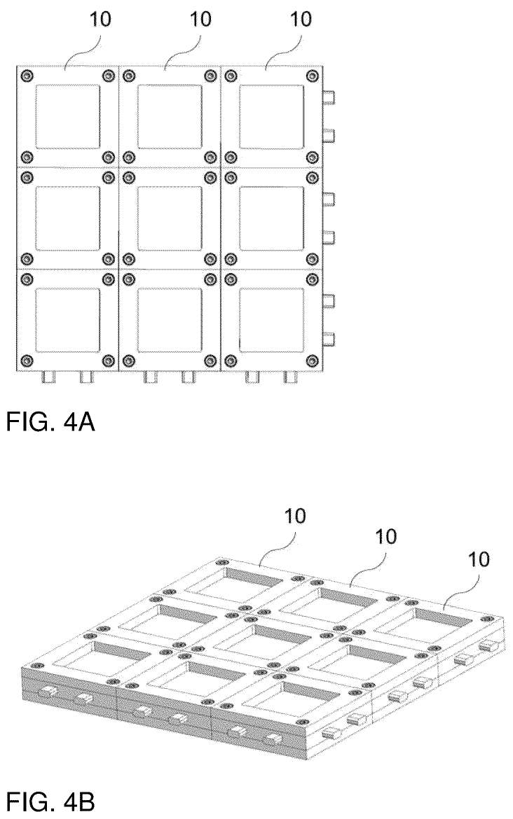

A plurality of guide blocks 10 may be connected to each other as shown in FIGS. 4A and 4B by joining the connecting portion 113 of any one guide block 10 to the receiving portion 114 of another guide block 10. A catalyst-coated membrane (CCM) may be manufactured by simultaneously and continuously coating a large-area electrolyte membrane with a plurality of coating layers. FIG. 4A shows a plan view showing a form in which the plurality of guide blocks 10 is connected according to various aspects of the present disclosure. FIG. 4B shows a perspective view showing a form in which the plurality of guide blocks 10 is connected according to various aspects of the present disclosure.

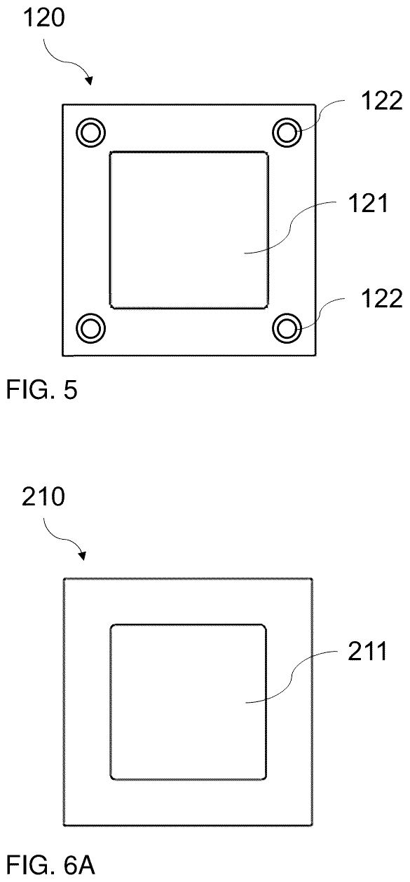

FIG. 5 shows a plan view of a second guide plate 120 according to various aspects of the present disclosure. The second guide plate 120 may have a frame shape having a second through-hole 121, which is the empty space in the center of the second guide plate 120. The electrolyte membrane is exposed to the outside through the second through-hole 121, and a catalyst layer is formed on the electrolyte membrane exposed to the second through-hole 121, thereby manufacturing a catalyst-coated membrane (CCM).

The second guide plate 120 may include second fastening grooves 122 formed by being recessed in or penetrating the peripheral surface of the second guide plate 120. By joining the first guide plate 110 and the second guide plate 120 with the fastening member 300 through the second fastening grooves 122 and applying restraining force to the electrolyte membrane interposed therebetween, dimensions of the electrolyte membrane may be prevented from changing during coating with the catalyst layer.

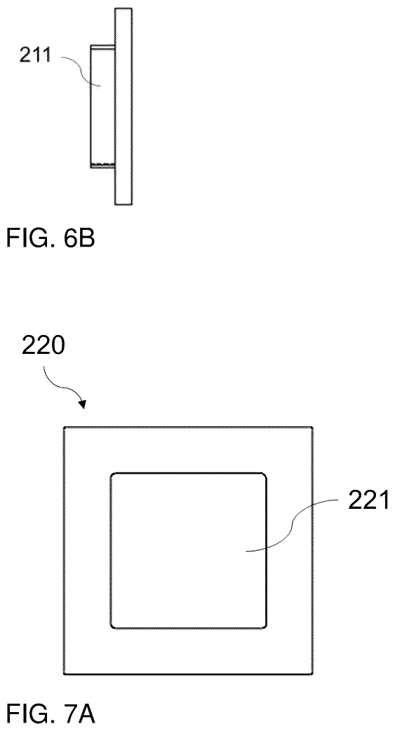

FIG. 6A shows a plan view of a first support plate 210 according to various aspects of the present disclosure. FIG. 6B shows a right side view of the first support plate 210 according to various aspects of the present disclosure. The first support plate 210 may include a first support portion 211 that protrudes from one surface thereof and has a position and shape corresponding to the position and shape of the first through-hole 111. The first support portion 211 may be inserted into the first through-hole 111 so that the first guide plate 110 and the first support plate 210 may be joined. When the first guide plate 110 and the first support plate 210 are joined, the electrolyte membrane is supported by the first support portion 211, and thus flatness of the electrolyte membrane may be maintained during coating with the catalyst layer. It is desirable for the protrusion height of the first support portion 211 to be the same as the thickness of the first guide plate 110.

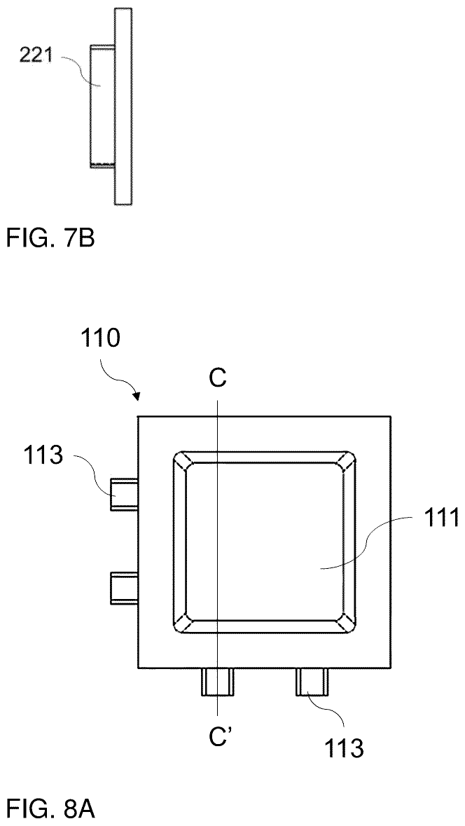

FIG. 7A shows a bottom view of a second support plate 220 according to various aspects of the present disclosure. FIG. 7B shows a left side view of the second support plate 220 according to various aspects of the present disclosure. The second support plate 220 may include a second support portion 221 that protrudes from one surface of the second support plate 220 and has a position and shape corresponding to the position and shape of the second through-hole 121. The second support portion 221 may be inserted into the second through-hole 121 so that the second guide plate 120 and the second support plate 220 may be joined. When the second guide plate 120 and the second support plate 220 are joined, the electrolyte membrane is supported by the second support portion 221, and thus flatness of the electrolyte membrane may be maintained during coating with the catalyst layer. It is desirable for the protrusion height of the second support portion 221 to be the same as the thickness of the second guide plate 120.

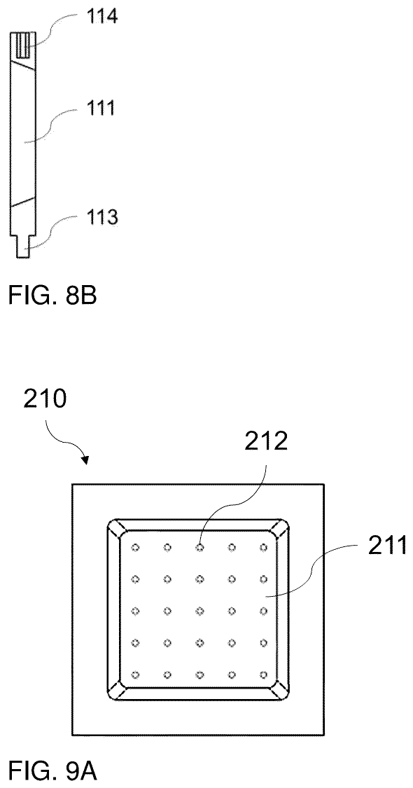

FIG. 8A shows a bottom view of a first guide plate 110 according to various aspects of the present disclosure. FIG. 8B shows a cross-sectional view along line C-C′ of FIG. 8A. Various aspects are characterized in that the inner wall surface of the first guide plate 110 is formed to be inclined to facilitate attachment and detachment of the first guide plate 110 and the first support plate 210. The inner wall surface of the first guide plate 110 may be formed to be inclined from one surface of the first guide plate 110 toward the remaining surface thereof so that the area of the first through-hole 111 increases toward the first support plate 210.

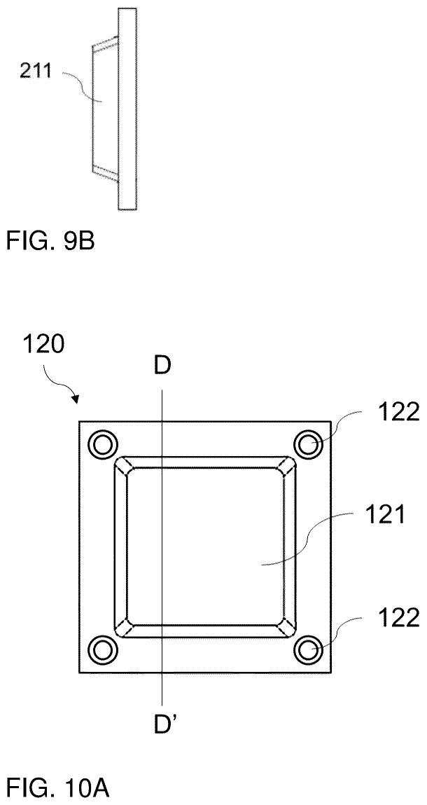

FIG. 9A shows a plan view of a first support plate 210 according to various aspects of the present disclosure. FIG. 9B shows a right side view of the first support plate 210 according to various aspects of the present disclosure. The first support plate 210 may include a first support portion 211 protruding from one surface of the first support plate 210. The first support portion 211 may be formed to protrude with the same inclination as the inclination of the inner wall surface of the first guide plate 110. The first support plate 210 may be more easily attached to or detached from the first guide plate 110.

The first support plate 210 may include a first gas discharge port 212 formed to penetrate the first support portion 211. When the first support plate 210 is inserted into the first guide plate 110, the first through-hole 111 may be sealed by the electrolyte membrane and the first support portion 211, causing damage to the electrolyte membrane by the pressure of the gas inside. The first gas discharge port 212 may be formed in the first support portion 211 to allow the gas to escape to the outside.

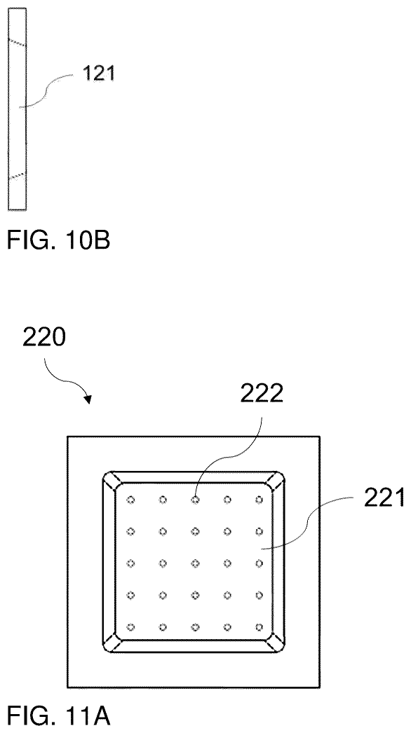

FIG. 10A shows a plan view of a second guide plate 120 according to various aspects of the present disclosure. FIG. 10B shows a cross-sectional view along line D-D′ of FIG. 10A.

The inner wall surface of the second guide plate 120 may be formed to be inclined from one surface of the second guide plate 120 to the remaining surface of the second guide plate 120 so that the area of the second through-hole 121 increases toward the second support plate 220.

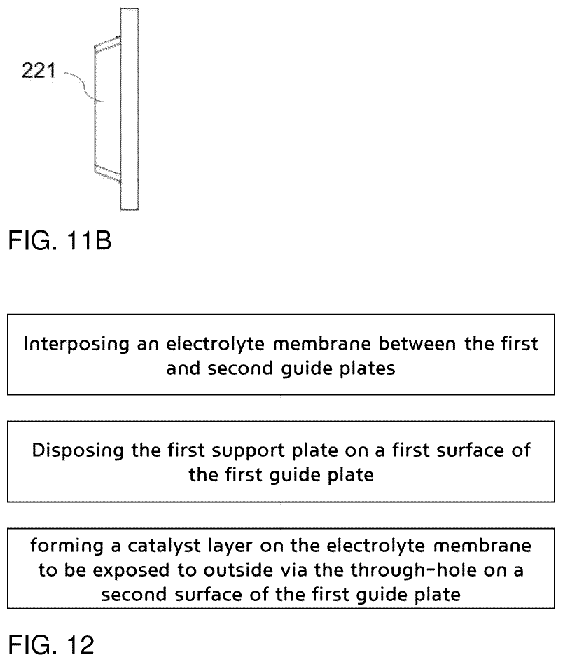

FIG. 11A shows a bottom view of a second support plate 220 according to various aspects of the present disclosure. FIG. 11B shows a left side view of the second support plate 220 according to various aspects of the present disclosure. The second support plate 220 may include a second support portion 221 protruding from one surface of the second support plate 220. The second support portion 221 may be formed to protrude with the same inclination as the inclination of the inner wall surface of the second guide plate 120. The second support plate 220 may be more easily attached to or detached from the second guide plate 120.

The second support plate 220 may include a second gas discharge port 222 formed to penetrate the second support portion 221. When the second support plate 220 is inserted into the second guide plate 120, the second through-hole 121 may be sealed by the electrolyte membrane and the second support portion 221, causing damage to the electrolyte membrane by the pressure of the gas inside. The second gas discharge port 222 may be formed in the second support portion 221 to allow the gas to escape to the outside.

FIG. 12 shows a method of manufacturing a catalyst-coated membrane (CCM) according to various aspects. The method may include interposing an electrolyte membrane between a pair of guide plates 100, disposing a support plate 200 on one surface of the guide plates 100, and forming a catalyst layer on the electrolyte membrane exposed to the outside on the remaining surface of the guide plates 100.

The electrolyte membrane may be impregnated with phosphoric acid. The electrolyte membrane may be interposed between the pair of guide plates 100 and the pair of guide plates 100 may be fastened with a fastening member 300 to apply restraining force to prevent the electrolyte membrane from moving.

After interposing the electrolyte membrane, for example, a first support plate 210 may be disposed on one surface of the guide plates 100. An electrolyte membrane may be placed on the first support portion 211 of the first support plate 210, and thus, the electrolyte membrane may become flat.

A catalyst layer may be formed on the electrolyte membrane exposed to the outside on the remaining surface of the guide plates 100, thereby forming a catalyst layer on one surface of the electrolyte membrane.

The first support plate 210 may be removed and, for example, a second support plate 220 may be disposed on the remaining surface of the guide plates 100. A stack of the catalyst layer and the electrolyte membrane may be placed on the second support portion 221 of the second support plate 220. A catalyst layer may be formed on the electrolyte membrane exposed to the outside on one surface of the guide plates 100, thereby forming catalyst layers on respective surfaces of the electrolyte membrane.

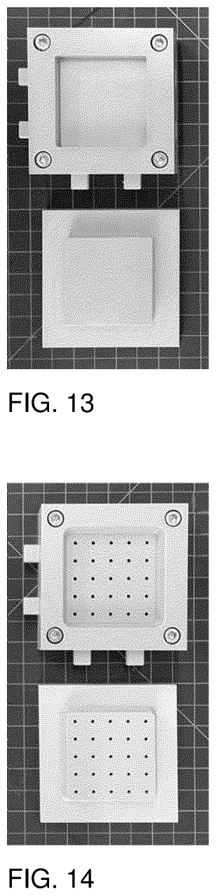

FIG. 13 shows a manufactured guide block 10 according to various aspects of the present disclosure. In FIG. 13, the upper part is a combination of a first guide plate 110, a second guide plate 120, and a first support plate 210, and the lower part is a second support plate 220.

FIG. 14 shows a manufactured guide block 10 according to various aspects of the present disclosure. In FIG. 14, the upper part is a combination of a first guide plate 110, a second guide plate 120, and a first support plate 210, and the lower part is a second support plate 220.

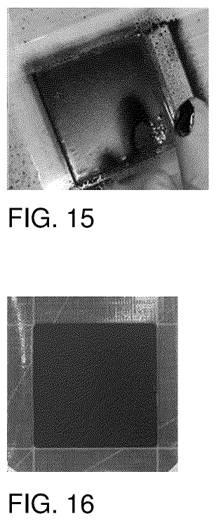

FIG. 15 shows a catalyst-coated membrane (CCM) manufactured without using a guide block. The electrolyte membrane used was one impregnated with phosphoric acid. When coating with the catalyst layer without using the guide block, the electrolyte membrane shrank and phosphoric acid inside the membrane leaked out.

FIG. 16 shows a catalyst-coated membrane (CCM) manufactured using the guide block according to the present disclosure. The same electrolyte membrane and catalyst layer as in FIG. 15 were used. Due to the use of the guide block, the electrolyte membrane did not shrink and thus there was no leakage of phosphoric acid. In addition, even when the loading of the catalyst layer was increased, a very uniform catalyst layer could be formed.

As is apparent from the foregoing, according to the present disclosure, a guide block capable of manufacturing a catalyst-coated membrane for a high-temperature polymer electrolyte membrane fuel cell can be obtained.

According to the present disclosure, a guide block capable of manufacturing a catalyst-coated membrane by directly applying a catalyst layer onto an electrolyte membrane can be obtained.

According to the present disclosure, a guide block capable of minimizing dimensional change in an electrolyte membrane can be obtained.

According to the present disclosure, a guide block capable of applying a catalyst layer onto both surfaces of an electrolyte membrane can be obtained.

According to the present disclosure, a guide block capable of manufacturing a catalyst-coated membrane by a continuous process can be obtained.

The effects of the present disclosure are not limited to the foregoing. It should be understood that the effects of the present disclosure include all effects that can be inferred from the description of the present disclosure.

Although specific embodiments of the present disclosure have been described, those having ordinary skill in the art will appreciate that the present disclosure may be embodied in other specific forms without changing the technical spirit or essential features thereof. Thus, the embodiments described above should be understood to be non-limiting and illustrative in every way.

What is claimed is:

1. A guide block comprising:
a pair of guide plates each having a frame shape and including a through-hole as an empty space at a center portion of each of the pair of guide plates; and
a support plate disposed on at least one surface of a guide plate of the pair of guide plates.

2. The guide block of claim 1, further comprising a fastening member configured to fasten the pair of guide plates by being inserted into a fastening groove, wherein each of the pair of guide plates comprises the fastening groove recessed in a peripheral surface of each of the pair of guide plates.

3. The guide block of claim 1, wherein at least one guide plate among the pair of guide plates comprises: at least one connecting portion protruding from an outer wall surface thereof, and at least one receiving portion recessed in the outer wall surface.

4. The guide block of claim 3, wherein the guide block is configured to be connected to another guide block by joining the at least one connecting portion of the guide block to the at least one receiving portion of the other guide block.

5. The guide block of claim 1, wherein the support plate comprises a support portion protruding from a surface of the support plate, and the support portion has a shape corresponding to a shape of the through-hole and is configured to be inserted into the through-hole such that the guide plate and the support plate are coupled.

6. The guide block of claim 5, wherein the support plate comprises a gas discharge port penetrating the support portion.

7. The guide block of claim 1, wherein an inner wall surface of the guide plate is inclined from a first surface of the guide plate toward a second surface of the guide plate.

8. A method of manufacturing a catalyst-coated membrane (CCM) using at least one guide block, where the at least one guide block includes: a first guide plate and a second guide plate, each having a frame shape and including a through-hole at a center portion thereof; and a first support plate and a second support plate, the method comprising:
interposing an electrolyte membrane between the first and second guide plates;
disposing the first support plate on a first surface of the first guide plate; and
forming a catalyst layer on the electrolyte membrane to be exposed to outside via the through-hole on a second surface of the first guide plate.

9. The method of claim 8, wherein each of the first and second guide plates comprises a fastening groove recessed in a peripheral surface of the first and second guide plates, and the at least one guide block further comprises a fastening member, and wherein the first and second guide plates are fastened to each other by inserting the fastening member into the fastening groove.

10. The method of claim 8, further comprising: forming at least one connecting portion protruding from an outer wall surface of the first guide plate; and forming at least one receiving portion recessed in an outer wall surface of the second guide plate.

11. The method of claim 10, wherein the at least one guide block includes a first guide block and a second guide block, and the first and second guide blocks are connected by joining the connecting portion of the first guide block to the receiving portion of the second guide block.

12. The method of claim 8, wherein the electrolyte membrane is impregnated with phosphoric acid.

13. The method of claim 8, wherein the first and second support plates each comprises a support portion that protrudes from a first surface of the first and second support plate and has a shape corresponding to a shape of the through-hole, and wherein the first and second guide plates and the first and second support plates are joined by inserting the support portion into the through-hole, and the electrolyte membrane is supported by the support portion.

14. The method of claim 13, further comprising: forming a gas discharge port penetrating the support portion of the first and second support plate.

15. The method of claim 8, wherein an inner wall surface of the first guide plate is inclined from a first surface of the first guide plate to a second surface of the first guide plate.

16. The method of claim 8, further comprising:
disposing the second support plate on a first surface of the second guide plate; and
forming the catalyst layer on the electrolyte membrane to be exposed to outside via the through-hole on a second surface of the second guide plate.
